(19) United States
(12) Patent Application Publication
(10) Pub. No.: US 2026/0134429 A1
(43) Pub. Date: May 14, 2026

(54) SYSTEMS AND METHODS FOR USE IN IDENTIFYING FEATURE DATA CONSISTENT WITH ABNORMAL NETWORK TRAFFIC

(71) Applicant: MASTERCARD INTERNATIONAL INCORPORATED, PURCHASE, NY (US)

(72) Inventors: Sean Conroy, Rockville Centre, NY (US); Aaron Shortell, Long Island City, NY (US); Aishwarya Asthana Jaggannath Shekhar Burns, Redwood City, CA (US); Chengxi Li, Greenwich, CT (US); Jong Bum Kim, O'Fallon, MO (US); Sayed Amin Afzal, Chesterfield, MO (US); Julia Sharon Gosset, Tarrytown, NY (US); Tyler Mey, St. Louis, MO (US); Zoltán Nagy, Budapest (HU)

(21) Appl. No.: 19/388,600

(22) Filed: Nov. 13, 2025

Related U.S. Application Data
(60) Provisional application No. 63/720,441, filed on Nov. 14, 2024.

(51) Int. Cl. G06Q 20/40; G06Q 20/42

(52) U.S. Cl. CPC G06Q 20/4014; G06Q 20/42

(57) ABSTRACT

Systems and methods are provided for identifying feature data consistent with abnormal network traffic. One example computer-implemented method includes, based on a request for a transaction at a first party, receiving, by a computing device, an authentication request for the transaction, the request including a credential for an account issued by an issuer; determining, by the computing device, using a trained model and feature data specific to the first party, that the transaction is part of an authentication BIN; and notifying, by the computing device, at least one of: the issuer of the credential and an acquirer of the first party, about the determined authentication BIN attack.

### CROSS-REFERENCE TO RELATED APPLICATION

This application claims the benefit of, and priority to, U.S. Provisional Patent Application No. 63/720,441, filed on Nov. 14, 2024. The entire disclosure of the above application is incorporated herein by reference.

### FIELD

The present disclosure generally relates to systems and methods for use in identifying feature data, such as, for example, velocity signals, etc., consistent with abnormal network traffic.

### BACKGROUND

This section provides background information related to the present disclosure which is not necessarily prior art.

Users are known to initiate interactions with parties in various manners. For example, a user (e.g., a consumer, etc.) may present a physical card to a physical location of a first party (e.g., a merchant, etc.), or to a virtual location of the first party (e.g., a website, application, etc.). In connection therewith, the first party may initiate various interactions with financial institutions, processing networks, etc., whereupon the first party is permitted to complete the transaction, by, for example, confirming approval of the transaction. The user is then permitted to secure the products or services in the exchange with the first party.

Where the user is a fraudster, the approval, or other signals, from the first party, may be relied upon to verify the existence of a legitimate account. In this way, a fraudster may initiate a transaction with estimated credentials (e.g., account numbers, etc.), and rely on the signals from the first party, or to the first party, to indicate which estimated credentials are legitimate and linked to actual/legitimate accounts. The fraudster may then leverage the legitimate accounts to defraud the users and/or institutions associated with the underlying accounts.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in identifying velocity signals consistent with abnormal network traffic;

FIG. 2 is a block diagram of an example computing device that may be used in the system of FIG. 1; and

FIG. 3 is a flow diagram of an example method, which may be implemented in connection with the system of FIG. 1, for identifying feature data consistent with abnormal network traffic.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

For certain first parties (e.g., merchants, etc.), initiation of a transaction includes presentment of an account credential, such as, for example, a primary account number (PAN), for a credit, debit, or prepaid account. In response, in some examples, the first party submits the transaction for authentication, whereupon an issuer of the account, or a processing network associated with the issuer and/or first party, provides analysis of the transaction and, ultimately, authenticates or declines to authenticate the transaction. In addition, the first party additionally or alternatively submits the transaction for authorization, whereupon the issuer of the account, or a processing network associated with the issuer and/or first party, may provide analysis of the transaction and, ultimately, authorize or decline the transaction.

In certain instances, the authentication (or authorization), or decline, is provided back to the first party and/or the user presenting the credentials. For a legitimate user, the authentication (or authorization) indicates that the transaction is being permitted, and the user is able to collect goods or services for which the user is paying. Conversely, for a fraudster, who submitted an estimated or guessed credential, the authentication response, for example, is an indication that the credential is indeed legitimate or valid. The fraudster may leverage computer implementations (e.g., bots, automated programs, etc.) to initiate hundreds or thousands of authentications or authorizations of transactions (e.g., at certain merchants, charities, or other platform that may employ lesser security measures (as compared to other platforms), etc.)), in this same manner, based on the estimated or guessed credential(s), whereby ones of the estimated or guessed credentials are verified as legitimate or valid, in which case, the credentials are sellable or usable for fraudulent purposes.

Uniquely, the systems and methods herein provide for identifying velocity signals, for transactions initiated at first parties, consistent with abnormal network traffic.

In particular, a processing network compiles specific feature data (e.g., transaction velocities, etc.) and/or snapshot data for one or more first parties, which is representative of the authentication request thereto. The data is leveraged, in connection with attack instances, to train a model to data such attack instances. The processing network then employs the trained model (e.g., through a directory server, etc.) to determine authentication requests are associated with the specific type of attack. The detection is in real-time, or near real-time, which permits the processing network to timely notify (e.g., via email, flags, reason codes, etc.) the acquirer and/or issuer. The acquirer and/or issuer then respond accordingly. In this manner, the systems and methods herein provide a technical solution, by leveraging a trained model to interpret data, in real-time, or near real-time, to detect abnormal network traffic as an attack enabled through technology (which may have been identified much later or not at all through conventional solutions). It should be understood that the technical solution addresses the timing of the specific attacks, which is often critical to the success of such attacks. In doing so, the systems and methos herein provide for a technical solution capable to address the attacks, which reduces network traffic, by halting the attacks, and increase response speed from issuers/acquirers, etc.

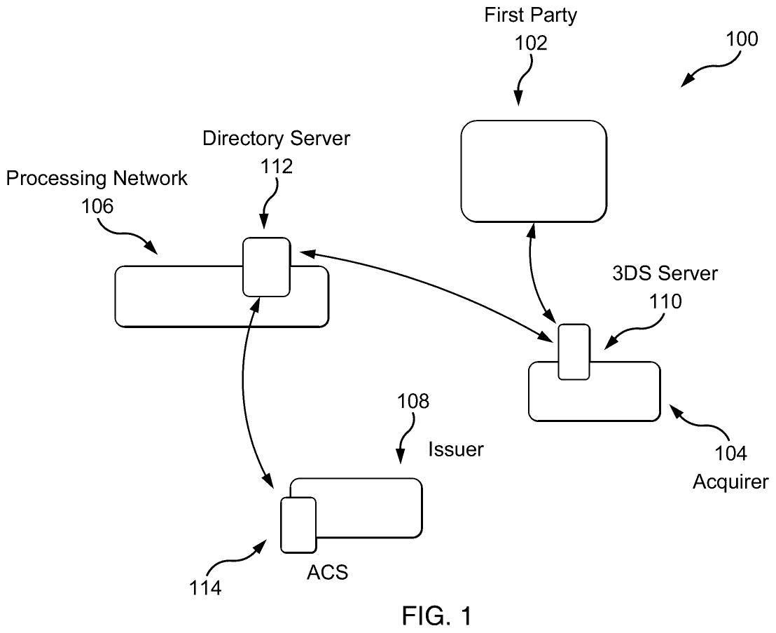

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between first parties, issuers, and/or processing network(s) in the system 100, privacy rules and regulations, etc.

As shown in FIG. 1, the illustrated system 100 generally includes a first party 102, an acquirer 104, a processing network 106, and an issuer 108, each of which is coupled to (and is in communication with) one or more network(s) (as indicated by the arrowed lines in FIG. 1). The one or more network(s) may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, one network may include a private payment network made accessible by the processing network 106 to the acquirer 104 and/or the issuer 108 and, separately, the public Internet, which may provide interconnection between the first party 102 and the processing network 106, etc.

The first party 102 of the illustrated system 100, in general, offers products (e.g., goods, services, etc.) for sale and/or sells products to users. In this example embodiment, the first party 102 includes a virtual merchant location, such as, for example, a website, network-enabled application, etc., whereby a user may initiate a transaction remote from the first party 102. In connection therewith, a user is instructed to enter a credential such as, for example, a primary account number (PAN) specific to an account, whereby the first party 102 is configured to initiate the transaction, as explained below. In one or more other examples, the credential may be accompanied by an expiration date and/or a card-verification-code (CVC), etc. It should be appreciated that the first party 102 may include a physical location in other system embodiments.

The acquirer 104 is configured to issue accounts, including, for example, banking accounts to first parties, such as, for example, the first party 102. The account, in the system 100, is the destination of funds for transactions initiated to pay the first party 102. As such, the acquirer 104 is generally a financial institution, such as, for example, a bank, credit union, etc. In addition, the acquirer 104 is configured to participate in the authentication and authorization of transactions to the accounts, through one or more approval processes, etc. Relatedly, the issuer 108 is configured to issue accounts, including, for example, payment accounts to users to be used to fund transactions at first parties, including the first party 102. The account is therefore the source account for funds for such transactions. Similarly, the issuer 108 is generally a financial institution, such as, for example, a bank, credit union, etc. The issuer 108 is also configured to participate in the authentication and authorization of transactions to the accounts, through one or more approval processes, etc.

The processing network 106 is configured to coordinate messaging associated with authentication and authorization of transactions between the first party 102 and other first parties and consumers (broadly, users) thereof, when a payment account is employed to fund the transactions. The processing network 106 is configured to coordinate that messaging by and through the acquirer 104 and the issuer 108.

In this example embodiment, the processing network 106 is configured consistent with one or more enhanced authentication schemes, such as, for example, the EMV 3D Secure (3DS) protocol (e.g., 3DS 2.3.1 protocol, etc.) (see, e.g., www.emvco.com/emv-technologies/3d-secure/ (which is incorporated herein by reference), etc.), including a present version thereof or other versions. As such, the system 100 further includes a 3DS server 110, a directory server 112, and an access control server (ACS) 114, as parts of the authentication scheme/architecture. The 3DS server 110 is incorporated in and/or associated with the acquirer 104, whereby reference herein to the acquirer 104 and the 3DS server 110 may be interchangeable. In addition, while the 3DS server 110 is illustrated as part of the acquirer 104, the 3DS server 110 may reside, in full or in part, at/in the first party 102, or the processing network 106. The directory server 112 is associated, in this example, with the processing network 106 (e.g., the MASTERCARD, VISA, etc. associated networks), and is configured as described below. The ACS 114, as illustrated in FIG. 1, is incorporated in and/or is part of the issuer 108 to facilitate (or implement) the 3DS protocol.

In addition, the processing network 106 is configured to analyze the transactions to assess the potential validity of the transactions (e.g., risk, etc.), whereby a risk score is assigned to each of the transactions. In connection therewith, the processing network 106 includes a decision management platform (DMP) (not shown) which is configured consistent with the description herein to assign the risk (and corresponding risk score) and to provide the risk (and/or risk score) to the directory server 112 to be communicated consistent with the above.

It should be understood that while the system 100 includes, specifically, the EMV 3D Secure protocol, other forms of authentication of credentials/users may be implemented in the system 100 (for imposing an authentication phase distinct from an authorization phase) and improved as described herein. The processing network 106 may be configured, for example, to implement token authentication and to incorporate the logic herein into flows associated therewith.

With continued reference to FIG. 1, as a user initiates a transaction at the first party 102, the first party 102 is configured to provide the credential received from the user to the 3DS server 110. In turn, the 3DS server 110 is configured to compile an authentication request (AReq) and to transmit the AReq to the directory server 112. The directory server 112 is configured to transmit the AReq to the ACS 114. In response, the ACS 114 is configured to assess the AReq and the underlying transaction, to compile an authentication response (ARes), and to transmit the ARes back to the directory server 112. The directory server 112 is configured to transmit the ARes to the 3DS server 110, which is configured to pass content from the ARes to the first party 102.

Next, the first party 102 is configured to compile an authorization request, which includes the credential from the user and the content from the ARes. The first party 102 is configured to transmit the authorization request to the acquirer 104. The acquirer 104 is configured, then, to transmit the authorization request to the issuer 108, via the processing network 106. The issuer 108 is configured to approve or decline the authorization of the transaction based on the authorization request (e.g., including the content from the ARes, etc.) and associated rules, logic, etc. In response to approval, the issuer 108 is configured to compile an authorization response and to transfer the authorization response to the acquirer 104, via the processing network 106. The acquirer 104 is configured to pass the authorization response back to the first party 102, whereupon the transaction is completed with the user.

The processing network 106 is configured to then clear and settle the transaction by and between the acquirer 104 and the issuer 108, whereby funds are transferred as appropriate.

In connection with the above, in this example embodiment, the processing network 106 is configured to compile transaction data into a database thereof for the transaction above and many other transactions coordinated through the processing network 106. The transaction data includes various details about the transactions, which involves ones of the first party 102, the acquirer 104 and the issuer 108. The transaction data includes, without limitation, amounts of the transactions, times/dates or timestamps, currency codes, account credentials (e.g., account numbers, etc.), expiration dates, CVCs, transaction IDs, terminal IDs, merchant ID s(MIDs), acquirer bank identification numbers (BINs), merchant category codes (MCCs), addresses (for the first party 102, etc.), and other suitable information, etc. The transaction data may further include device identifiers (e.g., IP address of user's computing device initiating the transaction, etc.), or geographic data for the user, etc.

It should be appreciated that the transaction data may be compiled and stored for both approved and declined transactions.

In this example embodiment, the processing network 106 is further configured to generate feature data, which includes aggregate data from the transaction data. Feature data may include, for example, velocity data for transactions various BINs, individually (e.g., velocities per BIN or potentially BIN range, etc.), for a time period such as, for instance, an hour, a four-hour period, a 12-hour period, a day, multiple days, a week, or other interval(s), for the first party 102, for the acquirer 104, and/or for the issuer 108, or other ones of these parties (or combinations thereof), etc. That is, the feature data may include short term data (e.g., hour(s), day(s), etc.), and/or long term data (e.g., week(s), month(s), etc.). The interval may be the time period, or it may be decay rates applied to velocities, influencing the temporal aspects of velocity variable calculations and analysis. The velocity data, for the intervals, may then indicate speed and intensity of changes in the data. The velocity data may be used in native form, and/or the velocity data may be further compiled into one or more ratios of different velocities, etc. In one example, the velocities may indicate hundreds, or thousands, etc., of transactions per hour at the first party 102, via the acquirer 104. Other feature data may include counts for repeated transactions, transaction volumes, amounts spent, low value transactions (e.g., transaction less than $1, etc.), and also declines, history of risk scores, invalid accounts, response codes, approval rates, approval/decline percentages, intervals, etc. It should be appreciated that feature data may also include aggregate(s) of feature data, whereby, for example, multiple velocities are aggregated to another velocity, or vice-versa, etc.

Further, the feature data is data specific to BINs, which defines ranges of accounts from the issuer 108 or other issuers. That is, for BIN 12345, the BIN is inclusive of each account number, which starts with BIN 12345, etc. As such, the specific authentication BIN attack is defined relative to other BINs, either at the first party 102 and/or other first parties, etc. Additional, the feature data may be data specific to Merchant-Acquirer IDs (MAIDs), which defines the unique combination of the first party 102 and the acquirer 104 and other combinations of first parties and acquirers, etc.

In general, in this example embodiment, the processing network 106 is configured to compile the feature data in real time (e.g., within milliseconds, within less than one second, etc.), or near real-time (e.g., within a few seconds, or minutes, etc.), as transactions are processed through the system 100.

Apart from the feature data, the processing network 106 is configured to compile discrete snapshot data for the first party 102, for the acquirer 104, and/or the issuer 108, or other ones of these parties (or combinations thereof), etc. For example, snapshot data may include data representative of transactions at the first party 102, which is compiled daily, weekly, monthly, or bi-monthly, etc., and which includes specific rule-based data (e.g., approval rates, transaction volumes, average mount spent, total amounts spent, low value transactions, approval/decline percentages, risk scores, authentication rates, invalid account/decline rates, average amounts, etc.). That is, the processing network 106 is configured to compile the snapshot data, from transaction data through the processing network 106, at one or more intervals. The interval(s) or window(s) of the snapshot data may be variable, and adjustable, depending on user preference, transaction data, etc. In general, the snapshot data is compiled as an interval cycle, and thus, in this example, is not compiled in real-time or near real-time, etc.

Given the above, the processing network 106 further includes a model, which is trained on data similar to the above data, for which specific types of attack instances have been estimated and/or verified. The model is configured, based on training via training data, then, to predict instances of attacks based on the feature data and/or snapshot data described above. The model, in this way, is configured to recognize patterns of feature data and/or data relative to snapshot data that are indicative of authentication BIN attacks (also referred to generally as BIN attacks, etc.). In this example embodiment, the model includes specifically an XGBoost (Extreme Gradient Boosting) model, for which the training is performed to define model hyper-parameters, including variables such as, for example, the number of boosting rounds, learning rate, and depth, among others.

In particular, in this example embodiment, the model is configured to leverage the XGBoost algorithm based on gradient boosting, which is optimized for high performance and scalability. In connection therewith, input data may be normalized as needed, for example, where variables have skewed distributions, whereby normalization includes subjecting the variables to log transformation. What's more, input data is further pre-processed by including default data for missing data values. In connection therewith, the input data, which includes the above feature data and the snapshot data, is leveraged to finely tune the model to distinguish between legitimate transactions and authentication bank identification number (BIN) attacks. Further, hand-crafted labels based on authentication and/or authorization assessments, along with empirical methods, are employed to approximate target events. To address the class imbalance, in this example, to the extent present, the processing network 106 may be configured to train the model on a balanced dataset, enhancing accuracy while maintaining sensitivity to attacks. The model's scalability and robustness then enable the processing network 106 to leverage the model, through further training, to adapt seamlessly to new risk patterns and evolving attack tactics, providing a resilient and efficient solution against authentication BIN events.

It should be appreciated that other models, such as, for example, decision tree models, etc., may be used in other embodiments.

Once trained, the processing network 106 is configured to employ the model in connection with transactions, whereby specific instances of attacks are recognized. In particular, in this example embodiment, the model is configured to rely on the feature data to identify “authentication BIN” attacks, in which one or more fraudsters repeatedly submit transactions for some amount to the first party 102, based on estimated or guessed credentials. In connection therewith, conventionally, the estimated credential may, for example, build on a BIN specific to the issuer 108, and the fraudster then relies on authentication responses and/or authorization results as verification or validation of the estimated or guessed credentials being valid credentials.

In this example embodiment, however, as above, the first party 102 is configured to provide the credential from the user to the 3DS server 110. In turn, the 3DS server 110 is configured to compile an authentication request (AReq) and to transmit the AReq to the directory server 112. The directory server 112 is configured, by the trained model, to assess the transaction based on feature data for the transaction, the first party 102, the acquirer 104, and/or, potentially, the issuer 108. Given specific feature data, the directory server 112 is configured, by the trained model, to assess the transaction and to generate a score indicative of a probability of that the transaction is part of an authentication BIN attack at the first party 102. That is, the processing network 106 is configured to retrieve the most recent snapshot data and the feature data, to calculate, using the training model (i.e., artifact(s) as configured by a model configuration), the probability score for an authentication BIN attack, in real-time or near real-time, and to then pass the score back to the directory server 112. The directory server 112 (or the processing network 106) is configured to compare the score to a threshold, and to determine (based on the comparison) that the snapshot data and/or feature data for the first party 102 (or at the combination of the first party 102 and the acquirer 104) is consistent with an authentication BIN attack (i.e., abnormal network traffic).

In response the directory server 112, or more generally, the processing network 106, is configured to notify the acquirer 104 and/or the issuer 108 of the detected attack. In one implemented example, the processing network 106 is configured to compile and transmit an email message to the acquirer 104, which includes, among other things, the identity of the first party 102, the merchant source of the detected attack, and also suggested remedial action(s) to be taken by the acquirer 104. The processing network 106 is further configured to compile and transmit an email message to the issuer 108, which includes, among other things, the merchant source of the detected attack, the account range/BIN of guessed/estimated credentials, and also suggested remedial action(s) to be taken by the issuer 108. Each of the acquirer 104 and/or the issuer 108 may be configured to react to the email message by implementing one or more of the suggested remedial action(s).

In additional or alternative implemented examples, the notification may be integrated into the transaction flow, and specifically, into the authentication protocol.

For instance, in response to the AReq, the directory server 112 is configured to set a flag in the AReq, prior to transmitting it to the ACS 114. That is, a message extension is employed to include a defined risk score, a reason code, and an explanation (e.g., “Authentication BIN Attack,” etc.). It should be understood that, in this example, the 998 dedicated score is used specifically to identify the specific attack as an authentication BIN attack. This specific score can be leveraged by the issuer 108 to configure one or more rules to invoke a security measure, such as, for example, to decline or challenge the authentication request as suspected fraud. The risk score may be generally consistent with a conventional risk score, but having the specific value outside of a conventional range. The reason code and explanation, in this example, are provided to supplement the score and replace typical variable content (e.g., a reason code from A-Z and a risk explanation of “low risk” or “non-low risk,” etc.) to further confirm the transaction as being involved in an authentication BIN attack (and not some other risk scenario).

Upon receipt of the AReq with the extension, from the directory server 112, the ACS 114 is configured to assess the transaction and other related transactions (e.g., to the same first party 102, or in the same account range (e.g., as defined by BIN, etc.), etc.). The ACS 114 is configured to confirm the attack, as appropriate, and to transmit an authentication response (ARes) to the directory server 112. The ARes includes a reason code specific, or unique, to the authentication BIN attack, such as, for example, R-98 reason code.

The directory server 112, in turn, is configured to pass the ARes to the 3DS server 110. Based thereon, the acquirer 104 is configured to identify the reason code for the authentication BIN and to pause transactions originating from the first party 102, in general or specific to some criteria (e.g., based on credentials, amounts, etc.), and the transaction, therefore, should not be submitted for authorization.

In connection with either notification from the processing network 106, the acquirer 104 and/or the issuer 108 may be required to further investigate the suspected authentication BIN attack and adjust security and/or rules associated with the accounts, the first party 102, etc. It should be appreciated that in addition to the flag or notification, the processing network 106 may be further configured to act on the identified suspected authentication BIN attack. For example, the processing network 106 may be configured to override content of the ARes from the ACS 114. That is, where the suspected authentication BIN attack is identified, but the ARes does not include the R-98 reason code specific to the attack, the processing network 106 (and specifically, the directory server 112) may be configured to include an override response code R-99, in the ARes, in place of the reason code therein. In this way, the processing network 106 is configured to act to ensure the suspected attack is signaled to the acquirer 104 even when the issuer 108 does not assign the expected R-98 reason code to the transaction. The R-99 reason code is indicative of the authentication BIN attack, but further indicates that the reason code has been added apart from the ACS 114. That said, it should be understood that the directory server 112, for example, may also include the R-98 reason code in other examples.

In another example, the processing network 106 may be configured to block transactions for a BIN, in which the suspected authentication BIN attack is identified. In particular, the directory server 112 may be configured to issue declines or other errors for credentials within the BIN range.

While only one first party 102, one acquirer 104, and one issuer 108 are illustrated in FIG. 1, it should be appreciated that any number of these parts and/or entities (and their associated components) may be included in the system 100, or may be included as a part of systems in other embodiments, consistent with the present disclosure. The processing network 106 is similarly configured to recognize authentication BIN attacks at the additional parties, through maintaining and/or determining feature data for the parties, etc.

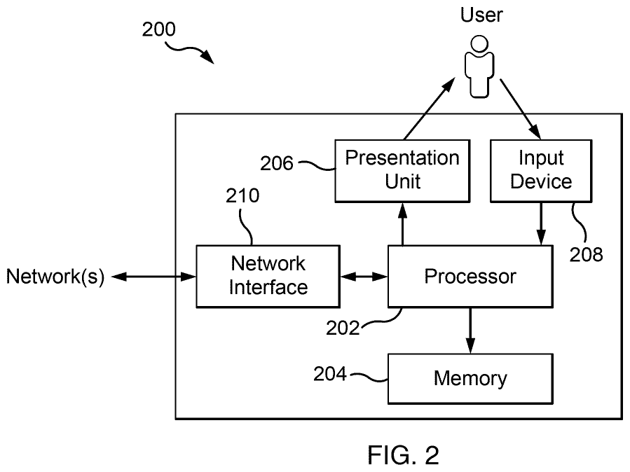

FIG. 2 illustrates an example computing device 200 that may be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to operate as described herein. In the example embodiment of FIG. 1, each of the first party 102, the acquirer 104, the processing network 106, the issuer 108, the 3DS server 110, the directory server 112, and the ACS 114 are understood to be included in, or as being generally implemented in, at least one computing device generally consistent with computing device 200, coupled to (and in communication with) the one or more networks. What's more, it should further be appreciated that the computing device 200 may be configured consistent with one or more cloud, fog, and/or mist computing architectures.

However, with that said, the system 100 should not be considered to be limited to the computing device 200, as described below, as different computing devices and/or arrangements of computing devices may be used.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), flash drives, CD-ROMs, thumb drives, floppy disks, tapes, hard disks, and/or any other type of volatile or nonvolatile physical or tangible computer-readable media. The memory 204 may be configured to store, without limitation, details of surge events, rules and exceptions, and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 and/or other computer system components configured to perform one or more of the various operations herein, whereby such performance improves operation of the computing device (as described herein) and transforms the computing device 200 into a special-purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, such as an indicator of an authentication BIN attack, etc., audibly or visually, for example, to a user of the computing device 200, etc. The presentation unit 206 may include, without limitation a liquid crystal display (LCD), a light-emitting diode (LED) or LED display, an organic LED (OLED) display, an “electronic ink” display, speakers, etc. In some embodiments, presentation unit 206 may include multiple devices.

In addition, the computing device 200 includes an input device 208 that receives inputs from the user of the computing device 200 (i.e., user inputs) such as, for example, instructions to remedy or address an authentication BIN attack, etc., as further described herein. The input device 208 may include a single input device or multiple input devices. The input device 208 is coupled to (and is in communication with) the processor 202 and may include, for example, a keyboard, a pointing device, a mouse, position sensors, biometric capturing device (e.g., fingerprint sensors, camera, palm reader, etc.) or any other type of sensor, a touch sensitive panel (e.g., a touch pad or a touch screen, etc.), another computing device, and/or an audio input device, etc. Further, in various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., Wi-Fi adapter, a near field communication (NFC) adapter, a Bluetooth adapter, etc.), a mobile network adapter, or other device capable of communicating to one or more different networks, including the one or more networks described above. Further, in some example embodiments, the computing device 200 may include the processor 202 and one or more network interfaces incorporated into or with the processor 202.

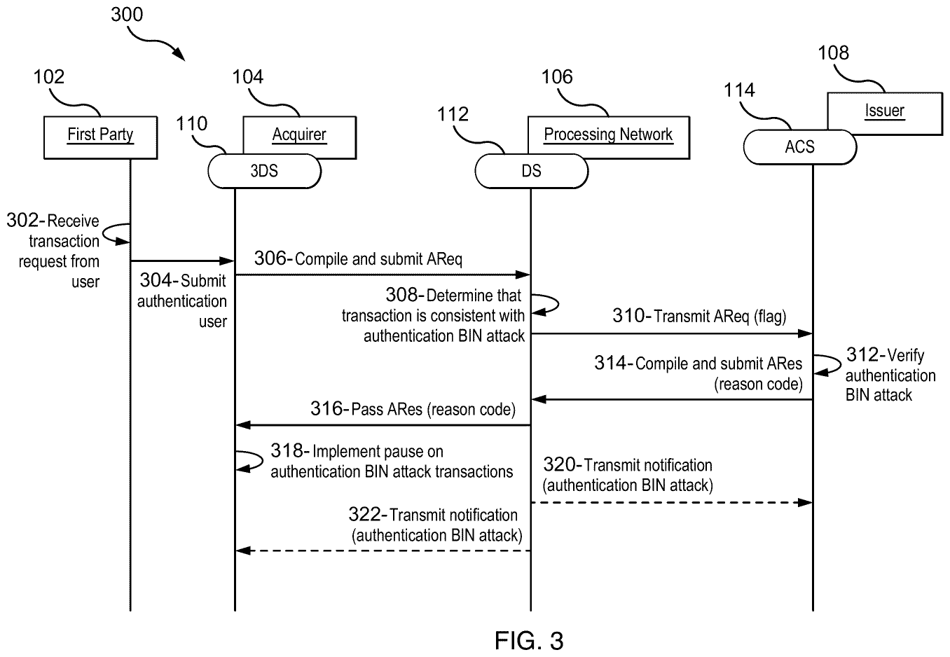

FIG. 3 illustrates an example computer-implemented method 300 for use in identifying velocity signals, for transactions initiated at first parties, consistent with abnormal network traffic. The example method 300 is generally described in connection with the system 100. Reference is also made to the computing device 200 of FIG. 2. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, the first party 102 receives, at 302, through a website or network-based application, in this example, a transaction request from the user. The transaction request includes a credential, which in this example, is an estimated or guessed credential, as the user is a fraudster. Relatedly, the transaction request can be one of thousands of authentication transaction requests to the first party 102 in the last one hour.

Based on the transaction request, the first party 102 submits, at 304, an authentication request to the 3DS server 110.

In response, at 306, the 3DS server 110 compiles and submits an authentication request (AReq) to the directory server 112. The AReq includes the credential from the user, and additional details of the transaction, such as, for example, a merchant ID for the first party 102, an amount, a currency, etc.

Based on the AReq, the directory server 112 determines, at 308, that the transaction indicated in the AReq is part of an authentication BIN attack initiated through the first party 102.

In particular, in this example embodiment, the directory server 112 retrieves feature data for the first party 102, the acquirer 104, and, potentially, the issuer 108 (based on the data included in the AReq (broadly, based on the AReq)), and provides the feature data (e.g., one or more velocities, invalid card transactions, etc.) to a trained XGBoost model, which, in this example, recognizes the velocities as indicative of an authentication BIN attack. In various examples, the directory server 112 may generate the velocities based on the received data. In any case, the determination by the trained XGBoost model may be based on any combination of the feature data, including, for example, velocities of transactions per hour, combinations of different velocities over one or more defined intervals, fraud rates (or invalid card account rates), or other data indicative of abnormal patterns for the first party 102 and/or the acquirer 104, etc.

Based on the determination, the directory server 112 updates the AReq to include a risk score specific to an authentication BIN attack (e.g., risk score 998, etc.), a reason code indicative of attention required, and explanation indicating “suspected authentication BIN attack” as a further indication of the authentication BIN attack (e.g., through message extension consistent with the EMV 3D Secure protocol, etc.). The updated data may generally be referred to as a flag, which is included in the AReq. At 310, the directory server 112 transmits the AReq, as updated with the flag, to the ACS 114.

At 312, the ACS 114 verifies the authentication BIN attack based on recent transaction data, in general or specific to the first party 102, the acquirer 104, etc. In doing so, the ACS 114 may verify transaction velocities for credentials in the same range as the credential included in the AReq, or other patterns or transactions and/or credentials being used in a previous interval, etc. Once verified, at 314, the ACS 114 compiles and submits an authentication response (ARes) to the directory server 112. The ARes includes a reason code specific to the authentication BIN attack. For example, the ACS 114 may compile a R-98 reason code that is specific to an authentication BIN attack into the ARes.

The directory server 112 passes, at 316, the ARes to the 3DS server 110. In response, the acquirer 104 identifies the reason code in the ARes (e.g., the R-98 reason code specific to an authentication BIN attack, etc.) and, in this example, implements, at 318, a pause of transactions associated with the authentication BIN attack. This may include all transactions involving the first party 102, or a subset of the transactions involving the first party 102. For example, transactions for a specific amount, or amount range may be paused, or transactions having a credential in the same range as the credential in the ARes may be paused, etc.

It should be appreciated that the ACS 114 may decline to include the specific reason code in the ARes, whereby the directory server 112 optionally may include a reason code indicative of the authentication BIN attack in the ARes (e.g., the R-99 reason code, in place of a reason code included by the ACS 114, etc.), etc., whereby the acquirer 104 and first party 102 are informed.

In addition, as shown in FIG. 3, the method 300 may further include notifications being transmitted, apart from the authentication scheme/architecture in FIG. 1. Specifically, the processing network 106, upon determining the transaction is consistent with an authentication BIN attack, may, optionally, as indicated by the dotted lines, transmit, at 320, a notification to the issuer 108, which informs of the authentication BIN attack and details thereof, and also transmits, at 322, a notification to the acquirer 104, which also informs of the authentication BIN attack and details thereof. The notification(s) may take the form of an operational email alert, which includes, as indicated, the information pertinent to the authentication BIN attack and potential remediation actions to be taken, etc. The email alert may include, then, without limitation, a first party name, a country code and ID, a 3DS Server Operator ID, an Acquirer BIN/ARID, a masked PAN credential or Account Number, an Issuer BIN, and a DS transaction ID (e.g., as generated by the directory server 112, etc.), etc.

The acquirer 104 and/or the issuer 108 may then respond to messaging related to the transaction with a suspected fraud reason code (e.g., R-11 reason code, etc.), and also choose to investigate further and/or to implement the remediation actions included in the notification (e.g., within minutes or hours of notification, etc.). The investigation may rely on, for example, surge events that are known or suspected to be occurring (e.g., unique purchase opportunities (e.g., ticket sales, etc.), etc.).

It should be appreciated that in addition to notifications, the processing network 106 may act to modify the ARes, as explained above, or to block transactions consistent with the authentication BIN attack, as appropriate.

In view of the above, the systems and method herein permit specific types of attacks, such as, for example, authentication BIN attacks, to be recognized as being consistent with abnormal network traffic. The recognition leverages the operations described herein, through the specific modeling of feature data, to provide timely detection. By recognizing the transactions as being consistent with abnormal network traffic, the relevant parties are notified, either through the authentication scheme/architecture, or apart therefrom, which permits the relevant parties to impose remedies to halt the authentication BIN attack. In doing so, the technical improvement herein mitigates the technical tool used for fraud, i.e., authentication BIN attacks, in a timely manner, in real-time, or near real-time, across the parties interacting with the processing network, which is a network-wide solution, and an enhancement over individual party-based solutions.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) based on a request for a transaction at a first party, receiving, by a computing device, an authentication request for the transaction, the request including a credential for an account issued by an issuer; (b) determining, by the computing device, using a trained model and feature data specific to the first party, that the transaction is part of an authentication BIN attack; and (c) notifying, by the computing device, at least one of: the issuer of the credential and an acquirer of the first party, about the determined authentication BIN attack, thereby permitting the issuer or the acquirer to impose measures related to the credential.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art, that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for identifying feature data consistent with abnormal network traffic, the method comprising:
based on a request for a transaction at a first party, receiving, by a computing device, an authentication request for the transaction, the request including a credential for an account issued by an issuer;
determining, by the computing device, using a trained model and feature data specific to the first party, that the transaction is part of an authentication (bank identification number) BIN attack; and
notifying, by the computing device, at least one of: the issuer of the credential and an acquirer of the first party, about the determined authentication BIN attack, thereby permitting the issuer or the acquirer to impose measures related to the credential.

2. The computer-implemented method of claim 1, wherein the feature data is specific to a BIN and includes one or more velocities of transactions at the first party, for one or more defined intervals.

3. The computer-implemented method of claim 2, wherein the trained model includes an XGBoost model.

4. The computer-implemented method of claim 1, wherein determining that the transaction is part of the authentication BIN attack includes:
retrieving, by the computing device, the feature data, as most recent feature data for the first party;
generating, using the trained model, a score indicative of a probability that the transaction is part of the authentication BIN attack; and
comparing, by the computing device, the generated score to a threshold.

5. The computer-implemented method of claim 4, wherein determining that the transaction is part of the authentication BIN attack is further based on snapshot data for the first party.

6. The computer-implemented method of claim 1, wherein notifying at least one of the issuer and the acquirer includes transmitting an operational email alert to at least one of the issuer and the acquirer.

7. The computer-implemented method of claim 1, wherein notifying at least one of the issuer and the acquirer includes:
transmitting an authentication request (AReq) to the issuer, the AReq including a score indicative of the authentication BIN attack, a first reason code for the authentication BIN attack, and/or a label indicating the authentication BIN attack.

8. The computer-implemented method of claim 1, wherein notifying at least one of the issuer and the acquirer includes:
transmitting an authentication response (ARes), from the issuer, to the acquirer, the ARes including a second reason code specific to the authentication BIN attack.

9. A system for use in identifying feature data consistent with abnormal network traffic, the system comprising:
a computing device, which is configured, by executable instructions, to:
based on a request for a transaction at a first party, receive an authentication request for the transaction, the request including a credential for an account issued by an issuer;
determine, using a trained model and feature data specific to the first party, that the transaction is part of an authentication (bank identification number) BIN attack; and
notify at least one of: the issuer of the credential and an acquirer of the first party, about the determined authentication BIN attack, thereby permitting the issuer or the acquirer to impose measures related to the credential.

10. The system of claim 9, wherein the feature data includes one or more velocities of transactions at the first party, for one or more defined intervals; and
wherein the feature data is specific to a BIN, or range of BINs.

11. The system of claim 10, wherein the trained model includes an XGBoost model.

12. The system of claim 9, wherein the computing device is configured, by the executable instructions, in determining that the transaction is part of the authentication BIN attack, to:
retrieve the feature data, as most recent feature data for the first party;
generate, using the trained model, a score indicative of a probability that the transaction is part of the authentication BIN attack; and
compare the generated score to a threshold.

13. The system of claim 9, wherein the computing device is configured, by the executable instructions, to determine that the transaction is part of the authentication BIN attack further based on snapshot data for the first party.

14. The system of claim 9, wherein the computing device is configured, by the executable instructions, in notifying at least one of the issuer and the acquirer, to:
transmit an operational email alert to at least one of the issuer and the acquirer.

15. The system of claim 9, wherein the computing device is configured, by the executable instructions, in notifying at least one of the issuer and the acquirer, to:
transmit an authentication request (AReq) to the issuer, the AReq including a score indicative of the authentication BIN attack, a first reason code for the authentication BIN attack, and/or a label indicating the authentication BIN attack.

16. The system of claim 9, wherein the computing device is configured, by the executable instructions, in notifying at least one of the issuer and the acquirer, to:
transmitting an authentication response (ARes), from the issuer, to the acquirer, the ARes including a second reason code specific to the authentication BIN attack.

17. A non-transitory computer-readable storage medium comprising executable instructions for identifying feature data consistent with abnormal network traffic, which when executed by at least one processor, cause the at least one processor to:
based on a request for a transaction at a first party, receive an authentication request for the transaction, the request including a credential for an account issued by an issuer;
determine, using a trained model and feature data specific to the first party, that the transaction is part of an authentication (bank identification number) BIN attack; and
notify at least one of: the issuer of the credential and an acquirer of the first party, about the determined authentication BIN attack, thereby permitting the issuer or the acquirer to impose measures related to the credential.

18. The non-transitory computer-readable storage medium of claim 17, wherein the feature data includes one or more velocities of transactions at the first party, for one or more defined intervals; and
wherein the trained model includes an XGBoost model.

19. The non-transitory computer-readable storage medium of claim 17, wherein the executable instructions, when executed by at least one processor, cause the at least one processor, in notifying at least one of the issuer and the acquirer, to:
transmit an operational email alert to at least one of the issuer and the acquirer.

20. The non-transitory computer-readable storage medium of claim 17, wherein the executable instructions, when executed by at least one processor, cause the at least one processor, in notifying at least one of the issuer and the acquirer, to:
transmit an authentication request (AReq) to the issuer, the AReq including a score indicative of the authentication BIN attack, a first reason code for the authentication BIN attack, and/or a label indicating the authentication BIN attack; and
transmitting an authentication response (ARes), from the issuer, to the acquirer, the ARes including a second reason code specific to the authentication BIN attack.
